(19) United States
(12) Patent Application Publication
(10) Pub. No.: US 2020/0153861 A1
(43) Pub. Date: May 14, 2020

(54) DECOY APPARATUS AND METHOD FOR EXPANDING FAKE ATTACK SURFACE USING DECEPTION NETWORK

(71) Applicant: ELECTRONICS AND TELECOMMUNICATIONS RESEARCH INSTITUTE, Daejeon (KR)

(72) Inventors: Kyung-Min PARK, Daejeon (KR); Dae-Sung MOON, Daejeon (KR); Ki-Jong KOO, Daejeon (KR); Ik-Kyun KIM, Daejeon (KR); Samuel WOO, Seoul (KR); Joo-Young LEE, Daejeon (KR)

(73) Assignee: ELECTRONICS AND TELECOMMUNICATIONS RESEARCH INSTITUTE, Daejeon (KR)

(21) Appl. No.: 16/679,622

(22) Filed: Nov. 11, 2019

(30) Foreign Application Priority Data
Nov. 13, 2018 (KR) 10-2018-0139020

(51) Int. Cl. H04L 29/06; H04L 29/12; H04L 12/741

(52) U.S. Cl. CPC H04L 63/1491; H04L 45/745; H04L 61/103

(57) ABSTRACT

Disclosed herein are a decoy apparatus and a method for expanding a fake attack surface using a deception network. The method includes determining, by a protected server, whether a packet is a target to be processed when the packet is received; converting, by the protected server, the packet and transmitting, by the protected server, the converted packet to the decoy apparatus of the deception network when the packet is determined not to be such a target; receiving, by the protected server, a response packet from a decoy virtual machine included in the decoy apparatus as a reply to the converted packet; and modifying, by the protected server, the response packet and transmitting, by the protected server, the modified response packet to the source from which the packet was transmitted, in order to expand the fake attack surface.

### CROSS REFERENCE TO RELATED APPLICATION

This application claims the benefit of Korean Patent Application No. 10-2018-0139020, filed Nov. 13, 2018, which is hereby incorporated by reference in its entirety into this application.

### BACKGROUND

### 1. Field

The present invention relates generally to technology for expanding a fake attack surface using a deception network, and more particularly to a deceptive defense method in which a protected server is used as a gateway that leads to a deception network in order to expand a fake attack surface.

### 2. Description of the Related Art

A deceptive defense is a method of increasing attack costs by showing incorrect information or a list comprising an excessive number of analysis targets to an attacker who attempts to select an attack target through network scanning.

Representative examples of deceptive defense techniques include a honeypot, a honeynet, a decoy, and the like. Here, the honeypot is a system intentionally installed in order to detect abnormal access, and the honeynet is a single network including the honeypot. The honeypot and the honeynet are deliberately exposed to attacks in order to induce attackers to perform attacks, whereby information about the attackers and attack patterns may be acquired.

Also, the decoy is similar to chaff and flares for aircraft defenses, and aims to protect a specific host by confusing the behavior of searching for an attack target or analyzing vulnerabilities.

These days, deceptive defense techniques are being used in various fields, such as network security, endpoint security, and the like, and it is important to generate a sophisticated decoy that resembles actual critical data in order to deceive attackers.

### SUMMARY

An object of the present invention is to provide a deception network that does not affect the configuration of the network infrastructure to be protected.

Another object of the present invention is to configure a deception network having a simple structure without using cumbersome network equipment or network equipment that imposes many limitations.

A further object of the present invention is to enable a scanning attempt for attacks to be immediately detected by a protected server rather than by network equipment.

Yet another object of the present invention is to ensure the efficiency of network address mutation techniques without being affected by network address mutation.

Still another object of the present invention is to solve a problem in which an attack target is easily recognized due to a small number of hosts for running services in an actual network.

Still another object of the present invention is to increase attack costs by deceiving an attacker into thinking that a large number of hosts exists in a network by arranging multiple decoys and allocating unused network addresses thereto.

In order to accomplish the above objects, a method for expanding a fake attack surface using a deception network according to the present invention may include determining, by a protected server, whether a packet is a target to be processed when the packet is received; when the packet is determined not to be the target to be processed, converting, by the protected server, the packet and transmitting, by the protected server, the converted packet to a decoy apparatus of the deception network; receiving, by the protected server, a response packet from a decoy virtual machine included in the decoy apparatus as a reply to the converted packet; and in order to expand the fake attack surface, modifying, by the protected server, the response packet and transmitting, by the protected server, the modified response packet to a source from which the packet determined not to be the target to be processed was transmitted.

Here, the deception network that is located at a reverse-side of the protected server may include one or more switches and the decoy apparatus including the one or more decoy virtual machines.

Here, determining whether the packet is the target to be processed may be configured to determine whether the packet is the target to be processed by the protected server, the protected server being selected from among multiple protected servers based on an ARP table of a router.

Here, the ARP table may be configured by mapping all of available IP addresses to MAC addresses of the protected servers and dividing all of the available IP addresses into as many sets as the number of protected servers.

Here, determining whether the packet is the target to be processed may be configured to determine whether the destination address of the packet is an unused address and to determine that the packet is not the target to be processed when the destination address of the packet is the unused address.

Here, determining whether the packet is the target to be processed may be configured to check destination information of the packet and to determine that the packet is not the target to be processed when the destination information does not match the IP address corresponding to the protected server or when a port corresponding to the destination information is not an open port.

Here, converting the packet and transmitting the converted packet to the decoy apparatus of the deception network may be configured to change the network address of the packet to the network address of the deception network and to transmit the packet, the network address of which is changed, to the decoy apparatus.

Here, the network band of the deception network may have the same size as the network address band of the protected server.

Here, receiving the response packet may be configured to receive the response packet for a service corresponding to the packet from the decoy virtual machine included in the decoy apparatus.

Here, modifying the response packet and transmitting the modified response packet may be configured to change the source address of the response packet, received from the decoy virtual machine, to the destination address of the packet received by the protected server and to transmit the response packet to the source from which the packet was transmitted.

Also, a decoy apparatus according to an embodiment of the present invention may include a bridge for receiving, from a protected server, a packet that is converted because the packet is determined not to be a target to be processed by the protected server; and one or more decoy virtual machines for receiving the converted packet from the bridge, generating a response packet as a reply to the converted packet, and transmitting the generated response packet to the protected server via the bridge. The response packet may be modified by the protected server and transmitted to a source from which the packet was transmitted.

Here, the decoy apparatus may be included in a deception network located at a reverse-side of the protected server.

Here, the converted packet may be generated in such a way that the protected server, which is selected from among multiple protected servers based on an ARP table of a router, converts the packet because the packet is determined not to be the target to be processed.

Here, the ARP table may be configured by mapping all of available IP addresses to MAC addresses of the protected servers and dividing all of the available IP addresses into as many sets as the number of protected servers.

Here, the converted packet may be generated in such a way that the protected server determines whether the destination address of the packet is an unused address and converts the packet because the packet is determined not to be the target to be processed when the destination address is the unused address.

Here, the converted packet may be generated in such a way that the protected server checks destination information of the packet and converts the packet because the packet is determined not to be the target to be processed when the destination information does not match the IP address corresponding to the protected server or when a port corresponding to the destination information is not an open port.

Here, the converted packet may be generated in such a way that the protected server changes the network address of the packet to the network address of the deception network.

Here, the network band of the deception network may have the same size as the network address band of the protected server.

Here, the decoy virtual machine may generate the response packet for a service corresponding to the converted packet.

Here, after the protected server changes the source address of the response packet to the destination address of the packet received by the protected server, the response packet may be transmitted to the source from which the packet was transmitted.

### BRIEF DESCRIPTION OF DRAWINGS

The above and other objects, features and advantages of the present invention will be more clearly understood from the following detailed description taken in conjunction with the accompanying drawings, in which:

FIG. 1 is a view that shows the configuration of a deception network system in which a decoy apparatus according to an embodiment of the present invention is applied;

FIG. 2 is a block diagram that shows the configuration of a decoy apparatus according to an embodiment of the present invention;

FIG. 3 is a flowchart for explaining a method for expanding a fake attack surface using a deception network according to an embodiment of the present invention;

FIG. 4 is a view for explaining an ARP table of a router according to an embodiment of the present invention;

FIG. 5 is a view for explaining a process in which a protected server processes a packet destined for an unused address according to an embodiment of the present invention; and

FIG. 6 is a view for explaining the process of expanding a fake attack surface by a deception network system according to an embodiment of the present invention.

### DETAILED DESCRIPTION

Because the present invention may be variously changed and may have various embodiments, specific embodiments will be described in detail below with reference to the attached drawings.

However, it should be understood that those embodiments are not intended to limit the present invention to specific disclosure forms and that they include all changes, equivalents or modifications included in the spirit and scope of the present invention.

The terms used in the present specification are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

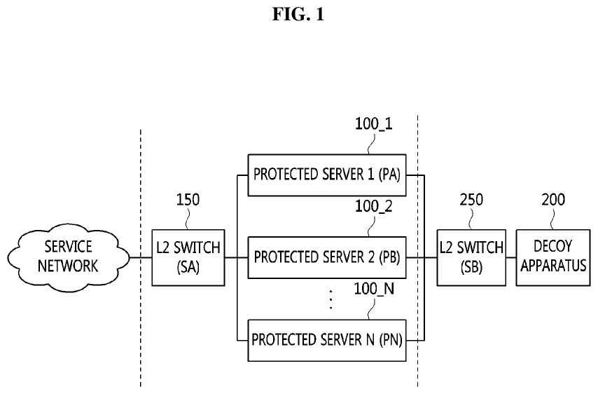

FIG. 1 is a view that shows the configuration of a deception network system in which a decoy apparatus according to an embodiment of the present invention is applied.

As shown in FIG. 1, a deception network including a decoy apparatus 200 according to an embodiment of the present invention is located behind (at the reverse-side of) the protected servers 100.

In general network infrastructure, a network device adjacent to the protected server 100 is an edge, and the protected server 100 is an end host. In this case, the existing deception network is accessible in the direction from the protected server 100, which is an end host, to the edge. However, the deception network according to an embodiment of the present invention is a reverse-side deception network, that is, the deception network is located at the reverse-side of the end host, rather than on the way from the end host to the edge.

As shown in FIG. 1, the reverse-side deception network (hereinafter, referred to as a ‘deception network’) may include one or more second L2 switches SB 250 and one or more decoy apparatuses 200. Here, the second L2 switch SB 250 may connect one or more protected servers 100 with the decoy apparatus 200 so as to form a single private network.

Also, the legacy protected server farm may include one or more first L2 switches SA 150 and one or more protected servers 100.

When an attacker performs network scanning on the server farm, the protected server 100, receiving a network-scanning packet, among the multiple protected servers 100 included in the server farm, may determine whether the received packet is a target to be processed thereby, and may transmit the packet to the decoy apparatus 200 in the deception network when it is determined that the packet is not such a target.

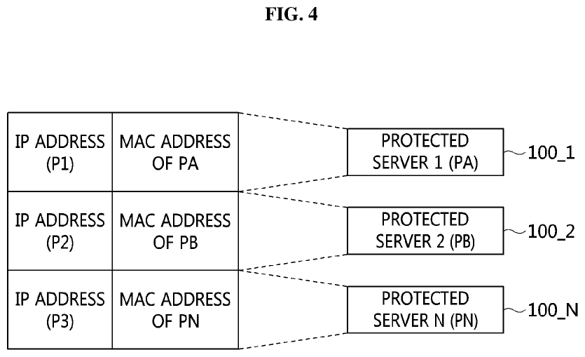

The protected server 100 may determine that packets are not targets to process when the packets are destined for any of unused addresses, other than currently occupied addresses and port numbers, and forward theses packets to the decoy apparatus 200 in the deception network. Here, in order to perform this process, the ARP table of a router adjacent to the protected server 100 must be configured as shown in FIG. 4, and the ARP table will be described in detail with reference to FIG. 4.

As described above, the deception network system in which a decoy apparatus according to an embodiment of the present invention is applied may be configured such that a packet that is determined not to be a target to be processed is transmitted to the decoy apparatus 200 in the deception network, and such that a response packet (a fake response packet) created by the decoy apparatus 200 may be returned to the source of the packet, whereby a fake attack surface may be expanded.

Network scanning is used in order to specify an attack target when an attacker starts to prepare for an attack. When an attacker finds an active attack target host within a specific network band through network scanning, the attacker may acquire a list comprising the IP addresses of active hosts in the network. Then, the attacker may acquire a service list of the found host. The service list may contain a list of open ports, the type of service for the open ports, version information, and the like. Then, the attacker exploits known vulnerabilities, or analyzes the service in order to search for other vulnerabilities.

The deception network according to an embodiment of the present invention may cause an attacker to unnecessarily waste time by making the amount of information acquired through network scanning much greater than the amount of actual information, and may induce the attacker to attack an invalid attack target, thereby making it difficult to access the actual protected server 100.

Also, the deception network according to an embodiment of the present invention may employ a container virtualization technique in order to show an attacker as many active host IP addresses and open service ports as possible. Because a system that actually occupies the corresponding IP address must be connected with a network when a response is generated in response to network IP scanning, multiple active hosts may be generated using the container virtualization technique.

The container virtualization technique is a lightweight method compared to a method in which the entire operating system is managed as a single virtual machine. Using the container virtualization technique, multiple network nodes may be generated, whereby the attack surface shown to an attacker may be hugely expanded. Also, because each container is able to actually run a specific service by opening a port, the ability of an attacker to detect a decoy simply by performing port scanning may be incapacitated.

Also, the deception network according to an embodiment of the present invention continuously moves the protected server 100 within a limited range by applying a network address mutation technique, which is one of Moving Target Defense (MTD) techniques in the networking field, thereby making it difficult for an attacker to find the protected server and preventing continuous interaction for analyzing vulnerabilities.

Also, a deception network according to a conventional art is difficult to apply because a decoy network is disposed in a separate network area inside a legacy network. Also, network resources are unnecessarily wasted for infrequently occurring attacks. However, the deception network system according to an embodiment of the present invention employs a deception-networking technique using the interaction with the protected server 100 without changing a network configuration by using the protected server 100 as a gateway. Accordingly, the deception network system according to the present invention may be simply applied, and the maintenance and management thereof are easy.

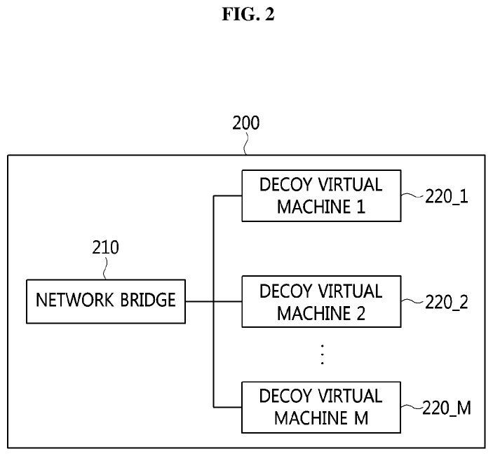

Hereinafter, the configuration of a decoy apparatus according to an embodiment of the present invention will be described in detail with reference to FIG. 2.

FIG. 2 is a block diagram that shows the configuration of a decoy apparatus according to an embodiment of the present invention.

As shown in FIG. 2, the decoy apparatus 200 may include a network bridge 210 and one or more decoy virtual machines 220. The decoy virtual machine 220 may be a decoy node, and the decoy apparatus 200 may be a decoy bed. The decoy apparatus 200 may control the multiple decoy virtual machines 220.

The decoy apparatus 200 may be included in a deception network located behind (at the reverse-side of) the protected server 100, and a packet may be received by using the protected server 100 as a gateway. The decoy apparatus 200 may generate a fake response packet in response to a packet that is determined not to be a target to be processed by the protected server 100, and may transmit the generated fake response packet to the source of the received packet via the protected server 100, thereby expanding a fake attack surface.

The network bridge 210 of the decoy apparatus 200 may receive the packet that is determined not to be the target to be processed from the protected server 100.

Also, the decoy virtual machine 220 may receive the corresponding packet from the network bridge 210, generate a fake response packet as a reply to the received packet, and transmit the generated fake response packet to the protected server 100 via the network bridge 210.

Here, the packet received by the network bridge 210 may be a packet that is converted by the protected server 100, and the generated fake response packet may be modified by the protected server 100 and then transmitted to the source of the packet.

The decoy virtual machines 220 may form a deception network, which is a private network separated from the network interface of the protected server 100. Here, the network band of the deception network may have the same size as the network address band of the protected server 100.

In FIG. 2, the packet received by the decoy apparatus 200 is a packet that is meant to be discarded because it is not a target to be processed by the protected server 100. However, the decoy apparatus 200 according to an embodiment of the present invention may receive the packet that is meant to be discarded, generate a fake response packet in response thereto, and transmit the fake response packet to the source of the received packet via the protected server 100.

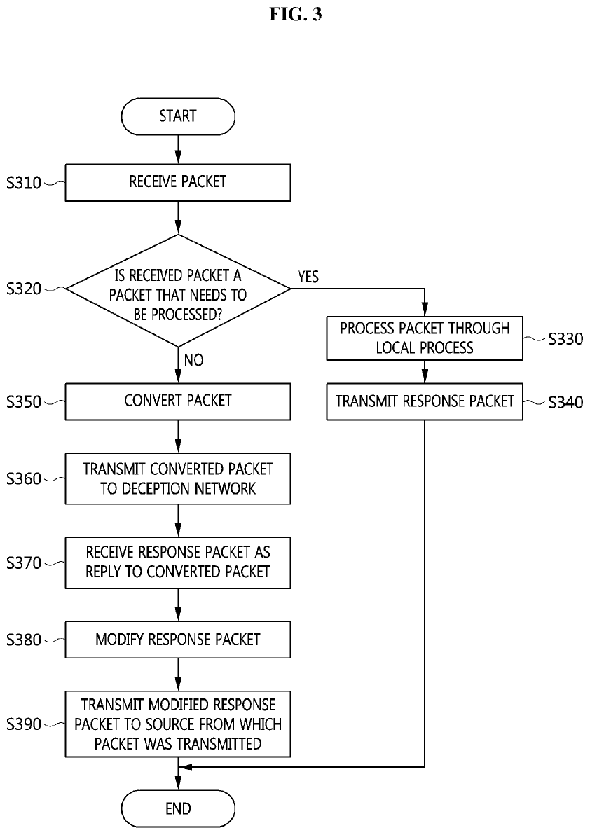

Hereinafter, a method for expanding a fake attack surface using a deception network, performed by a deception network system, according to an embodiment of the present invention will be described in detail with reference to FIGS. 3 to 6.

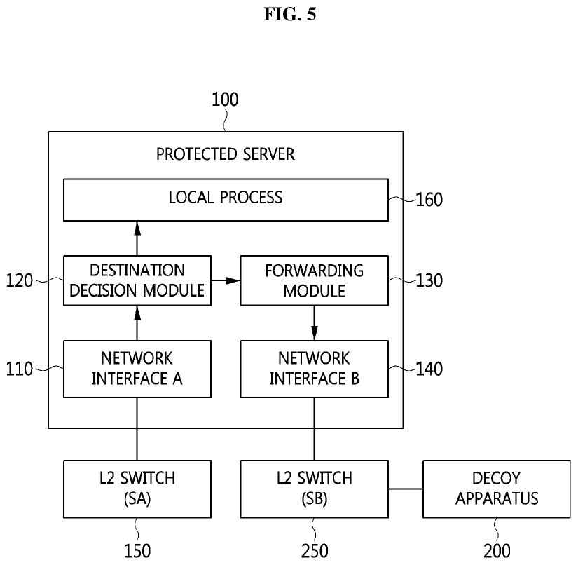

FIG. 3 is a flowchart for explaining a method for expanding a fake attack surface using a deception network according to an embodiment of the present invention, FIG. 4 is a view for explaining an ARP table of a router according to an embodiment of the present invention, and FIG. 5 is a view for explaining a process in which a protected server processes a packet destined for an unused address according to an embodiment of the present invention.

First, the protected server 100 receives a packet at step S310 and determines whether the received packet is a target to be processed thereby at step S320.

The first network interface 110 of the protected server 100 may receive a packet from a service network through a first L2 switch 150, and when the packet is received, the protected server 100 may determine whether the received packet is a target to be processed thereby.

Meanwhile, the ARP table 400 of a router (or an L3 switch), which is adjacent to the protected server 100, may be a static table, as shown in FIG. 4. Also, when a packet is received, the router (or the L3 switch) may transmit the received packet to the protected server 100 corresponding thereto based on the ARP table 400.

The indices of the ARP table 400 are IP addresses, and the ARP table 400 may be configured by mapping all of available IP addresses to the MAC addresses of the protected servers 100 and dividing all of the available IP addresses into as many sets as the number of protected servers 100.

For example, when an IP address band in a first set P1 ranges from 192.168.0.2 to 192.168.0.80 in FIG. 4, the packet received at an IP address included in the first set P1 may be forwarded to the first protected server PA, which is mapped to the first set P1.

Each of the first protected server PA, the second protected server PB, and the third protected server PC may use IP addresses in any one of the first set P1, the second set P2, and the third set P3, mapped thereto in the ARP table.

Also, when the protected server receives a packet, the destination decision module 120 thereof checks the destination of the received packet, thereby determining whether the received packet is a target to be processed by the protected server.

Here, when the destination information of the received packet matches the IP address and open port of the protected server 100, the protected server 100 determines that the packet is a target to be processed thereby. Conversely, when the destination does not match the IP address of the protected server 100 or when the port corresponding to the destination information is not an open port, the protected server 100 determines that the received packet is not a target to be processed thereby.

That is, when the protected server 100 receives a packet destined for an unused address, other than the IP address and port number occupied thereby, the protected server 100 may determine that the received packet is not a target to be processed thereby. That is, the protected server 100 may determine that the received packet corresponds to scanning by an attacker.

When the received packet is determined to be a target to be processed (YES at step S320), the protected server 100 generates a response packet at step S330 through a local process 160 and transmits the generated response packet to the source, from which the received packet was transmitted, at step S340.

Conversely, when it is determined that the received packet is not a target to be processed (NO at step S320), the protected server 100 converts the received packet at step S350 and transmits the same to the deception network at step S360 in order to generate a fake response packet in response to scanning by an attacker.

The conventional system discards a received packet when the received packet is determined not to be a target to be processed. However, in the deception network system according to an embodiment of the present invention, the forwarding module 130 of the protected server 100 forwards the received packet to the decoy apparatus 200 of the deception network via the second network interface 140.

Here, the second L2 switch SB 250 and the second network interface 140 of the protected server 100 in FIG. 5 may form separate networks. For example, when the network address band of the protected server 100 is 172.30.10.0/24, the network band of the deception network, including the second L2 switch SB 250 and the decoy apparatus 200, may be 192.168.10.0/24, which has the same size as the network address band of the protected server 100.

The address ‘192.168.10.1’, which is the address of a network gateway, may be allocated to the second network interface 140, and the remaining addresses may be allocated to the decoy virtual machines 220. Also, no IP address may be allocated to the bridge of the decoy apparatus 200.

At step S350, the protected server 100 may change the network address of the received packet and transmit the same to the decoy apparatus 200. For example, when the destination address of the received packet is 172.30.10.100 and when the corresponding address is an unused address, the protected server 100 may change the network address 172.30.10 to 192.168.10, which is the address of the deception network. Then, the protected server 100 may transmit the packet, the destination address of which is changed to 192.168.10.100, to the decoy apparatus 200.

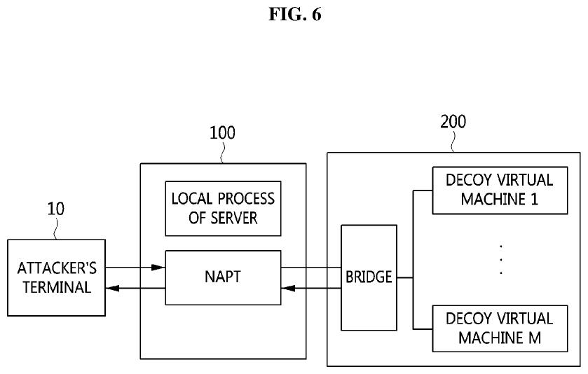

FIG. 6 is a view for explaining the process of expanding a fake attack surface in a deception network system according to an embodiment of the present invention.

When a received packet is determined to be a target to be processed, the protected server 100 determines that the corresponding packet is transmitted from a valid source and forwards the same to an upper layer, thereby processing the same through a local process thereof based on the general processing flow.

However, when it is determined that the received packet is not a target to be processed by the protected server 100, the Network Address and Port Translation (NAPT) module of the protected server 100 regards the received packet as a packet transmitted by an attacker's terminal 10 and transmits the same to the decoy apparatus 200 of the deception network, as shown in FIG. 6. In this case, the NAPT module may convert the packet before transmitting the packet to the decoy apparatus 200.

The NAPT module shown in FIG. 6 may perform the same functions as the destination decision module 120, the forwarding module 130, and the network interface 110 or 140 shown in FIG. 5.

When it receives the converted packet, the decoy apparatus 200 of the deception network generates a response packet in response thereto and transmits the same to the protected server 100. Here, the response packet generated by the decoy apparatus 200 is a fake response packet, and the decoy apparatus 200 may generate the fake response packet on the assumption that a service corresponding to the received packet is actually running. Then, the decoy apparatus 200 may transmit the generated fake response packet to the protected server 100. Here, the destination address of the fake response packet is the source of the received packet, that is, the attacker's terminal.

Referring again to FIG. 3, when it receives the response packet from the decoy apparatus 200 at step S370 in reply to the converted packet, the protected server 100 modifies the received response packet at step S380. Then, the protected server 100 transmits the modified response packet to the source of the packet at step S390.

Here, the response packet received at step S370 is a fake response packet generated by the decoy apparatus 200 in order to falsely expand the attack surface presented to an attacker.

The protected server 100 changes the source address of the fake response packet received from the decoy apparatus 200 to the destination address of the packet received by the protected server 100. In order to deceive an attacker, which is the source of the packet, into thinking that the fake response packet is a normal response packet generated through an actual running service, the protected server 100 may change the source address of the fake response packet, which will be transmitted to the source of the packet, to the destination address of the packet, and may then transmit the fake response packet, the source address of which is changed, to the source of the packet.

For example, it may be assumed that the protected server 100 is allocated a network address that ranges from 172.30.1.50 to 172.30.1.100 and that the address of the protected server 100 is 172.30.1.100.

Here, when an attacker transmits a scanning packet destined for the address 172.30.1.50, a response packet for the corresponding scanning packet may be generated by the decoy apparatus 200. Then, the response packet generated by the decoy apparatus 200 is transmitted to the attacker via the protected server 100, in which case the protected server 100 changes the source address of the response packet to the destination address of the scanning packet transmitted by the attacker and transmits the response packet to the attacker in order to deceive the attacker. That is, the protected server 100 may change the source address of the response packet to 172.30.1.50, which is the destination address of the scanning packet transmitted by the attacker, and transmit the response packet to the attacker that transmitted the scanning packet.

As described above, the deception network system according to an embodiment of the present invention falsely generates a response packet for deceiving an attacker and transmits the same to the attacker, thereby expanding a fake attack surface. The decoy apparatus 200 generates a fake response packet and transmits the same to the protected server 100, and the protected server 100 changes the network address of the source of the fake response packet and transmits the same to the attacker.

Because a response to the transmitted packet is received normally, the attacker erroneously determines that a certain network host actually exists even though the address to which the packet was transmitted is an unused address. As described above, an attacker is induced to trust false information in the reconnaissance process for a network attack, whereby the number of targets to be analyzed for an attack may be increased and the attacker may be confused.

According to the present invention, a deception network that does not affect the configuration of the network infrastructure to be protected may be provided.

Also, according to the present invention, a deception network having a simple structure may be configured without using cumbersome network equipment or network equipment that imposes many limitations.

Also, according to the present invention, a scanning attempt for attacks may be immediately detected by a protected server rather than by network equipment.

Also, according to the present invention, the efficiency of network address mutation techniques may be ensured without being affected by network address mutation.

Also, according to the present invention, a problem in which an attack target is easily recognized due to a small number of hosts for a running service in an actual network may be solved.

Also, according to the present invention, it is possible to increase attack costs by deceiving an attacker into thinking that a large number of hosts exists in a network by arranging multiple decoys and allocating unused network addresses thereto.

As described above, the decoy apparatus and the method for expanding a fake attack surface using a deception network according to the present invention are not limitedly applied to the configurations and operations of the above-described embodiments, but all or some of the embodiments may be selectively combined and configured, so that the embodiments may be modified in various ways.

What is claimed is:

1. A method for expanding a fake attack surface using a deception network, comprising:
determining, by a protected server, whether a packet is a target to be processed when the packet is received;
when the packet is determined not to be the target to be processed, converting, by the protected server, the packet and transmitting, by the protected server, the converted packet to a decoy apparatus of the deception network;
receiving, by the protected server, a response packet from a decoy virtual machine included in the decoy apparatus as a reply to the converted packet; and
in order to expand the fake attack surface, modifying, by the protected server, the response packet and transmitting, by the protected server, the modified response packet to a source from which the packet determined not to be the target to be processed was transmitted.

2. The method of claim 1, wherein the deception network that is located at a reverse-side of the protected server comprises:
one or more switches; and
the decoy apparatus including the one or more decoy virtual machines.

3. The method of claim 1, wherein determining whether the packet is the target to be processed is configured to determine whether the packet is the target to be processed by the protected server, the protected server being selected from among multiple protected servers based on an ARP table of a router.

4. The method of claim 3, wherein the ARP table is configured by mapping all of available IP addresses to MAC addresses of the protected servers and dividing all of the available IP addresses into as many sets as a number of protected servers.

5. The method of claim 4, wherein determining whether the packet is the target to be processed is configured to:
determine whether a destination address of the packet is an unused address; and
determine that the packet is not the target to be processed when the destination address of the packet is the unused address.

6. The method of claim 5, wherein determining whether the packet is the target to be processed is configured to:
check destination information of the packet; and
determine that the packet is not the target to be processed when the destination information does not match an IP address corresponding to the protected server or when a port corresponding to the destination information is not an open port.

7. The method of claim 1, wherein converting the packet and transmitting the converted packet to the decoy apparatus of the deception network is configured to change a network address of the packet to a network address of the deception network and transmit the packet, the network address of which is changed, to the decoy apparatus.

8. The method of claim 7, wherein a network band of the deception network has a same size as a network address band of the protected server.

9. The method of claim 7, wherein receiving the response packet is configured to receive the response packet for a service corresponding to the packet from the decoy virtual machine included in the decoy apparatus.

10. The method of claim 9, wherein modifying the response packet and transmitting the modified response packet is configured to change a source address of the response packet, received from the decoy virtual machine, to a destination address of the packet received by the protected server and to transmit the response packet to the source from which the packet was transmitted.

11. A decoy apparatus, comprising:
a bridge for receiving, from a protected server, a packet that is converted because the packet is determined not to be a target to be processed by the protected server; and
one or more decoy virtual machines for receiving the converted packet from the bridge, generating a response packet as a reply to the converted packet, and transmitting the generated response packet to the protected server via the bridge,
wherein the response packet is modified by the protected server and transmitted to a source from which the packet was transmitted.

12. The decoy apparatus of claim 11, wherein the decoy apparatus is included in a deception network located at a reverse-side of the protected server.

13. The decoy apparatus of claim 11, wherein the converted packet is generated in such a way that the protected server, which is selected from among multiple protected servers based on an ARP table of a router, converts the packet because the packet is determined not to be the target to be processed.

14. The decoy apparatus of claim 13, wherein the ARP table is configured by mapping all of available IP addresses to MAC addresses of the protected servers and dividing all of the available IP addresses into as many sets as a number of protected servers.

15. The decoy apparatus of claim 14, wherein the converted packet is generated in such a way that the protected server determines whether a destination address of the packet is an unused address and converts the packet because the packet is determined not to be the target to be processed when the destination address is the unused address.

16. The decoy apparatus of claim 15, wherein the converted packet is generated in such a way that the protected server checks destination information of the packet and converts the packet because the packet is determined not to be the target to be processed when the destination information of the packet does not match an IP address corresponding to the protected server or when a port corresponding to the destination information is not an open port.

17. The decoy apparatus of claim 12, wherein the converted packet is generated in such a way that the protected server changes a network address of the packet to a network address of the deception network.

18. The decoy apparatus of claim 17, wherein a network band of the deception network has a same size as a network address band of the protected server.

19. The decoy apparatus of claim 17, wherein the decoy virtual machine generates the response packet for a service corresponding to the converted packet.

20. The decoy apparatus of claim 19, wherein, after the protected server changes a source address of the response packet to a destination address of the packet received by the protected server, the response packet is transmitted to the source from which the packet was transmitted.
